(19) United States
(12) Patent Application Publication
(10) Pub. No.: US 2015/0074635 A1
(43) Pub. Date: Mar. 12, 2015

(54) Systems and Methods for Building Custom Mobile Device Applications Using a Mobile Devlce

(71) Applicants: Vito Margiotta, Lecce (IT); Gabriel Gurovich, Santiago (CL); Asaf Kindler, Jerusalem (IL)

(72) Inventors: Vito Margiotta, Lecce (IT); Gabriel Gurovich, Santiago (CL); Asaf Kindler, Jerusalem (IL)

(21) Appl. No.: 14/462,446

(22) Filed: Aug. 18, 2014

Related U.S. Application Data
(60) Provisional application No. 61/866,940, filed on Aug. 16, 2013.

(51) Int. Cl. G06F 9/44

(52) U.S. Cl. CPC G06F 8/20
USPC 717/105

(57) ABSTRACT

Systems and methods for developing applications for mobile computer devices using a mobile computer device are provided. A system for developing applications for mobile computer devices utilizing a mobile computer device includes a database that is electronically accessible over at least one network system and stores features, templates and/or modules for building mobile device applications through the system. An application for building mobile device applications is included that is hosted at least partially on a server and electronically accessible over at least one network system to a user mobile computer device. The application is configured to provide a user of the user mobile computer device access to the features, templates and/or modules stored in the database, and to allow the user to build a mobile computer device application by selecting, editing and customizing the features, templates and/or modules, and to publish the mobile computer device application for use by mobile computer devices.

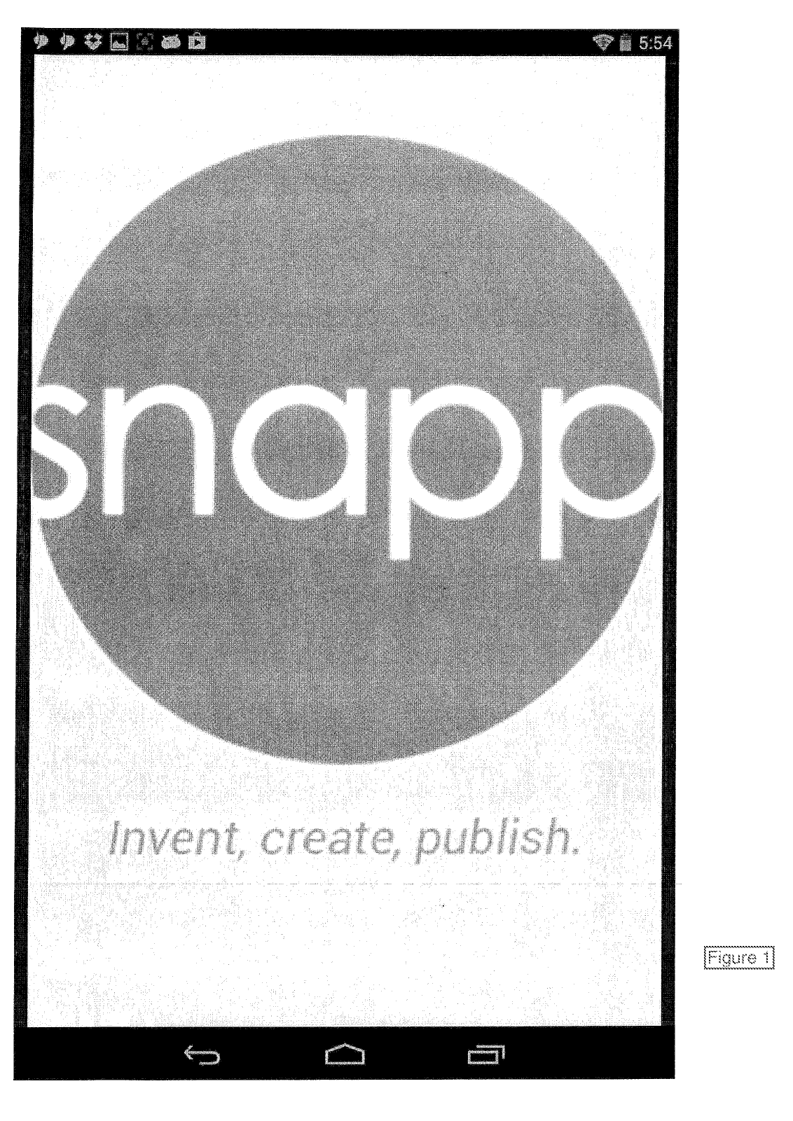

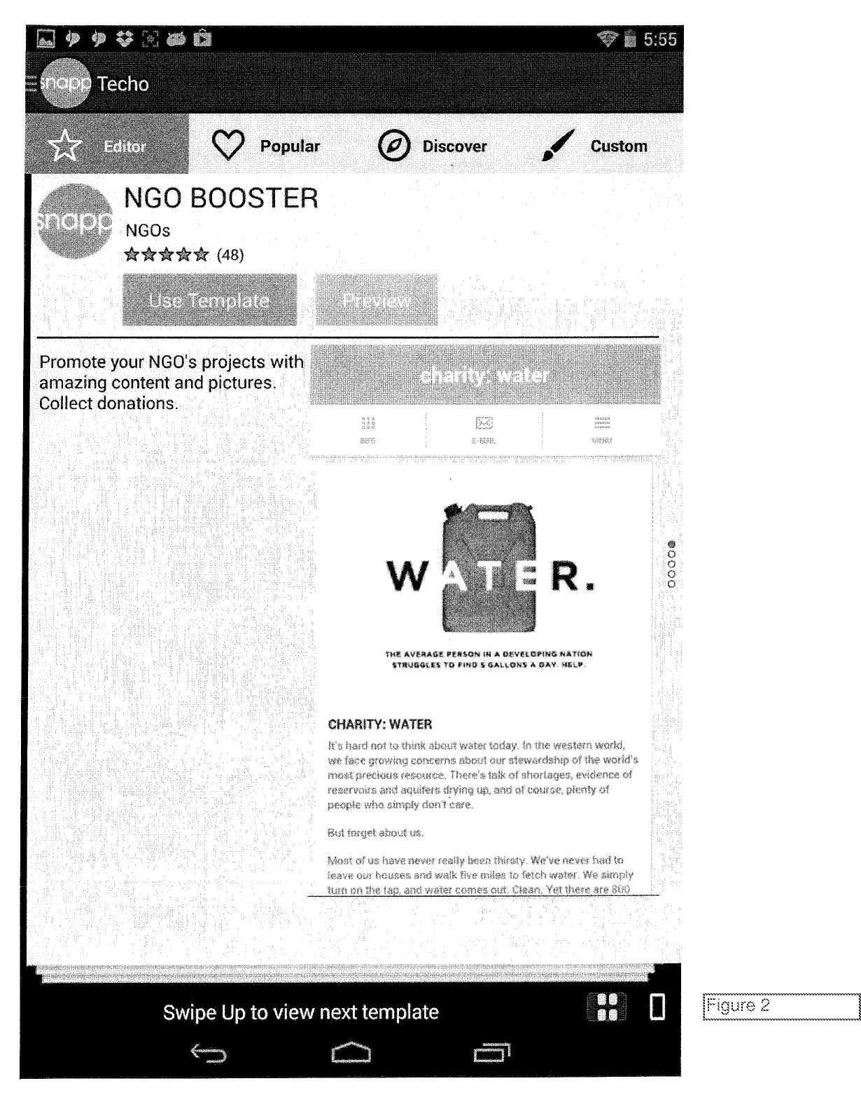

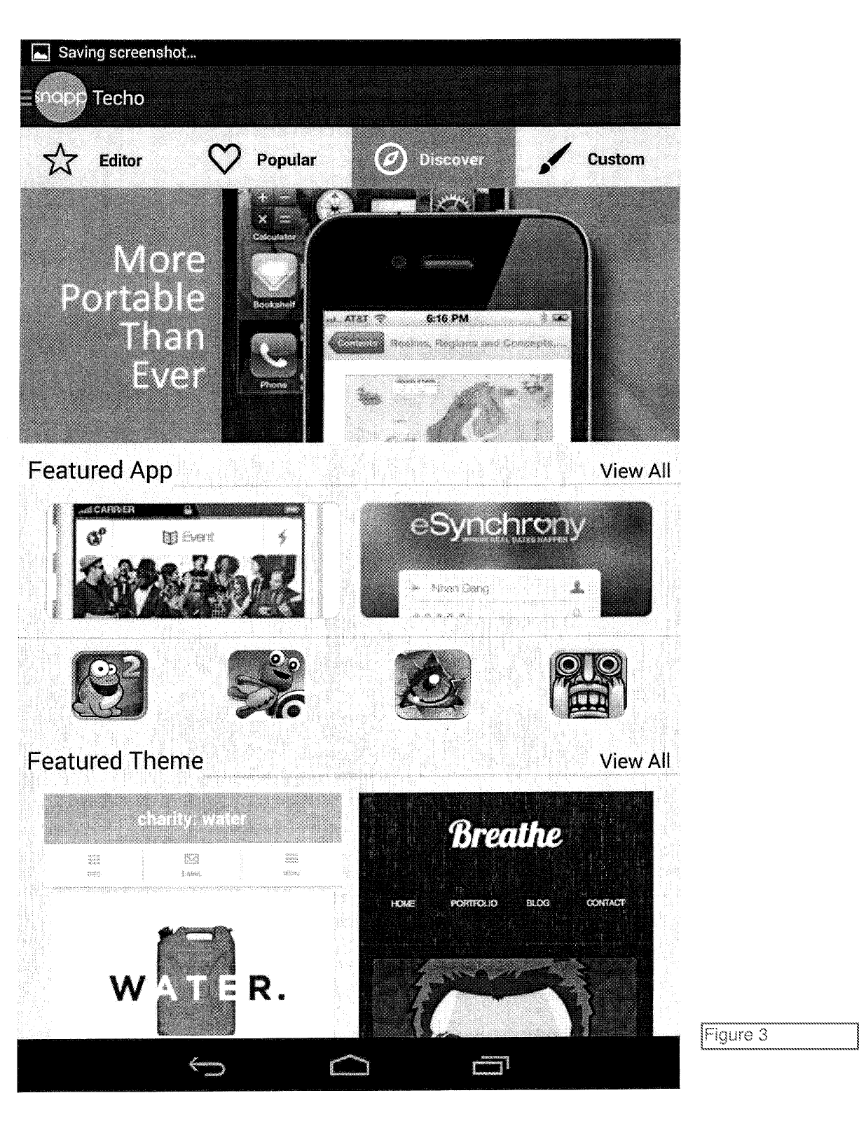

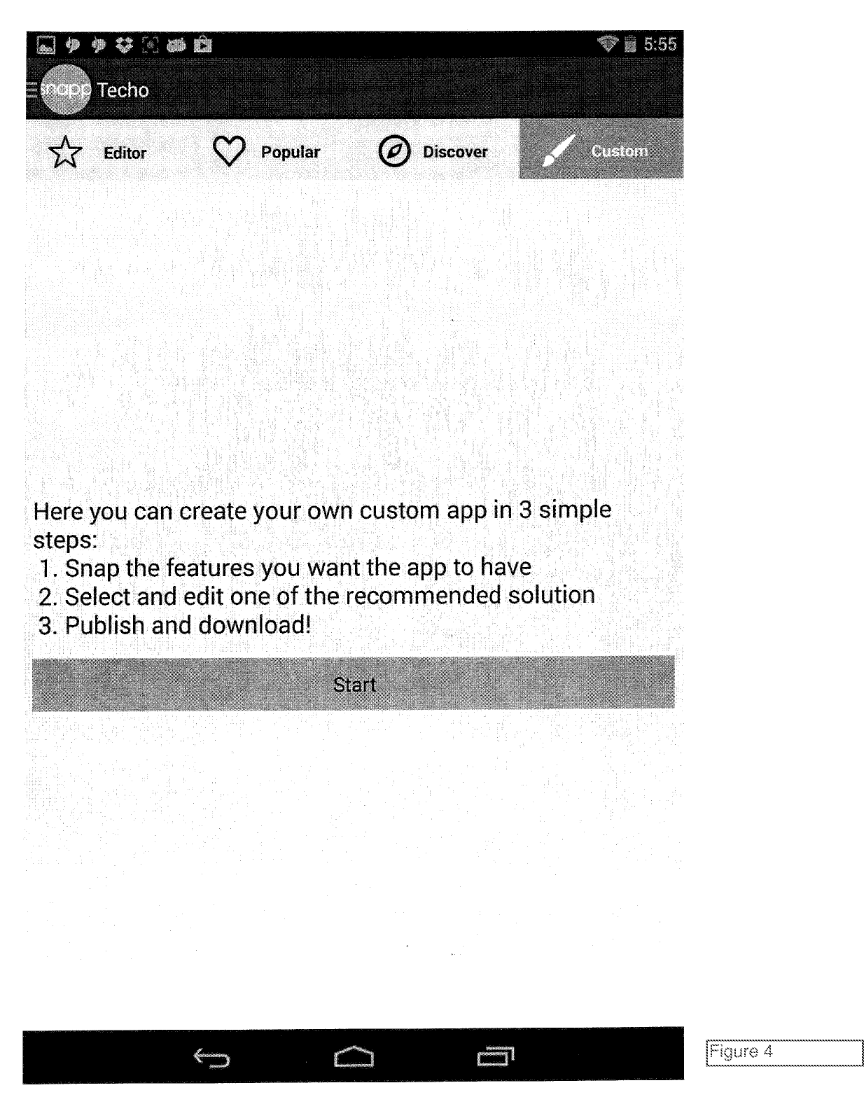

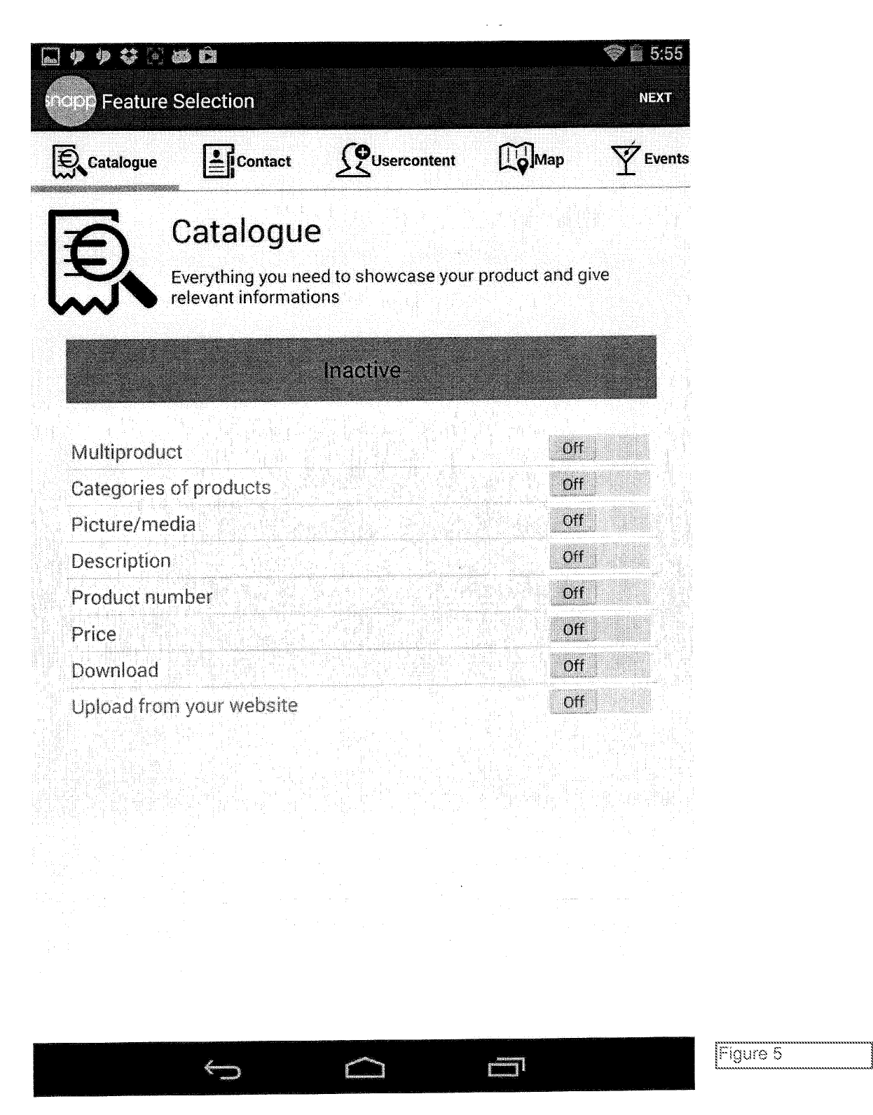

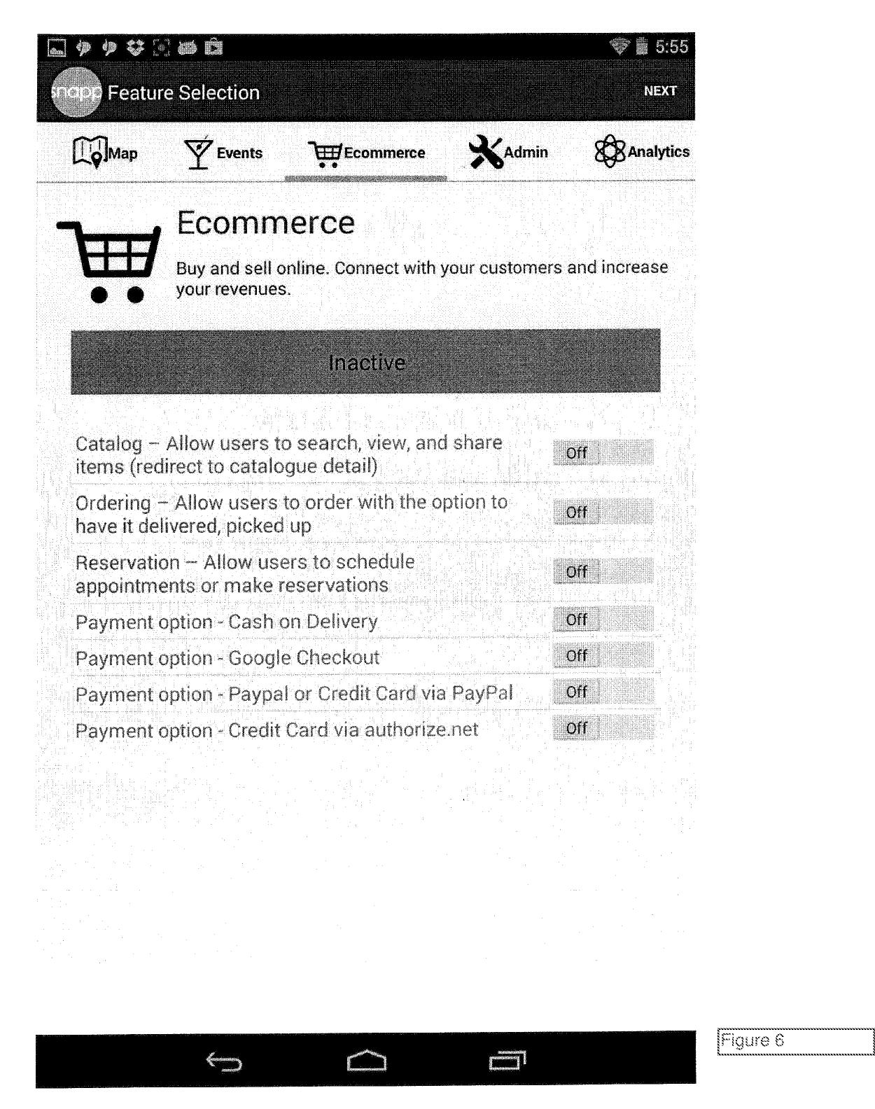

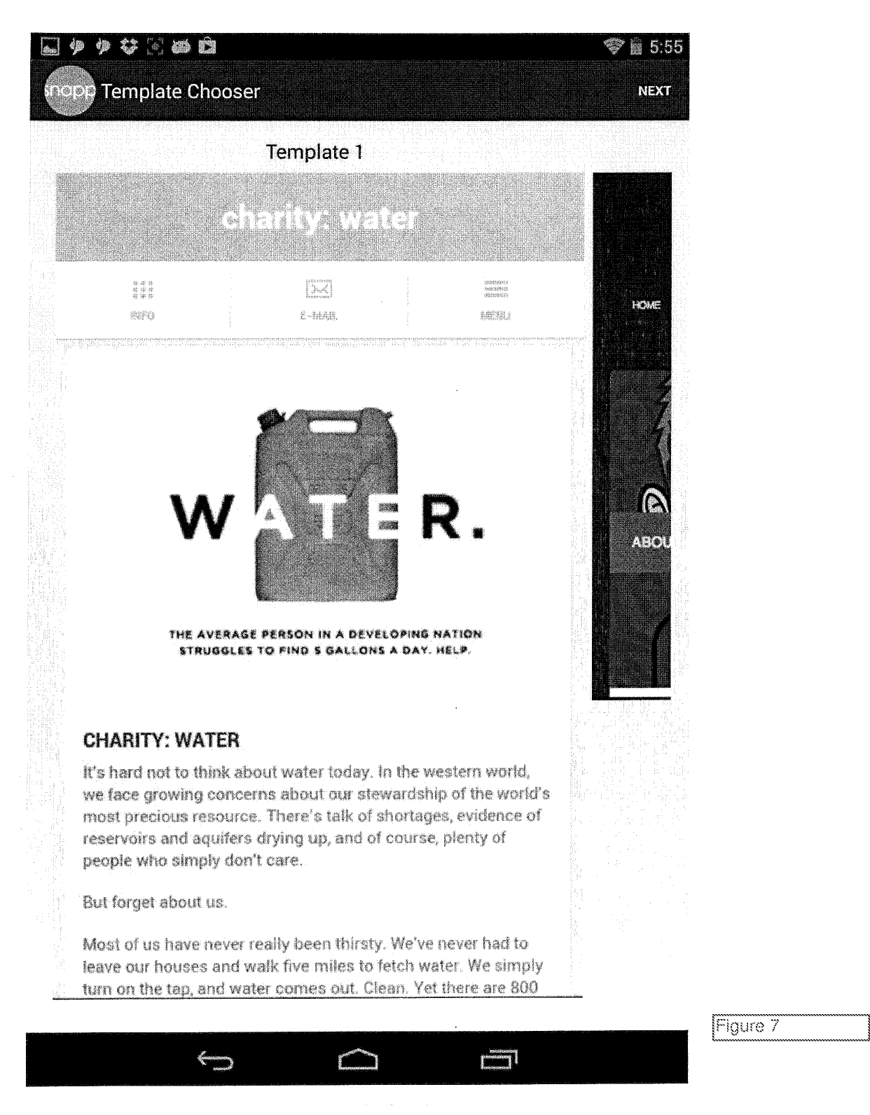

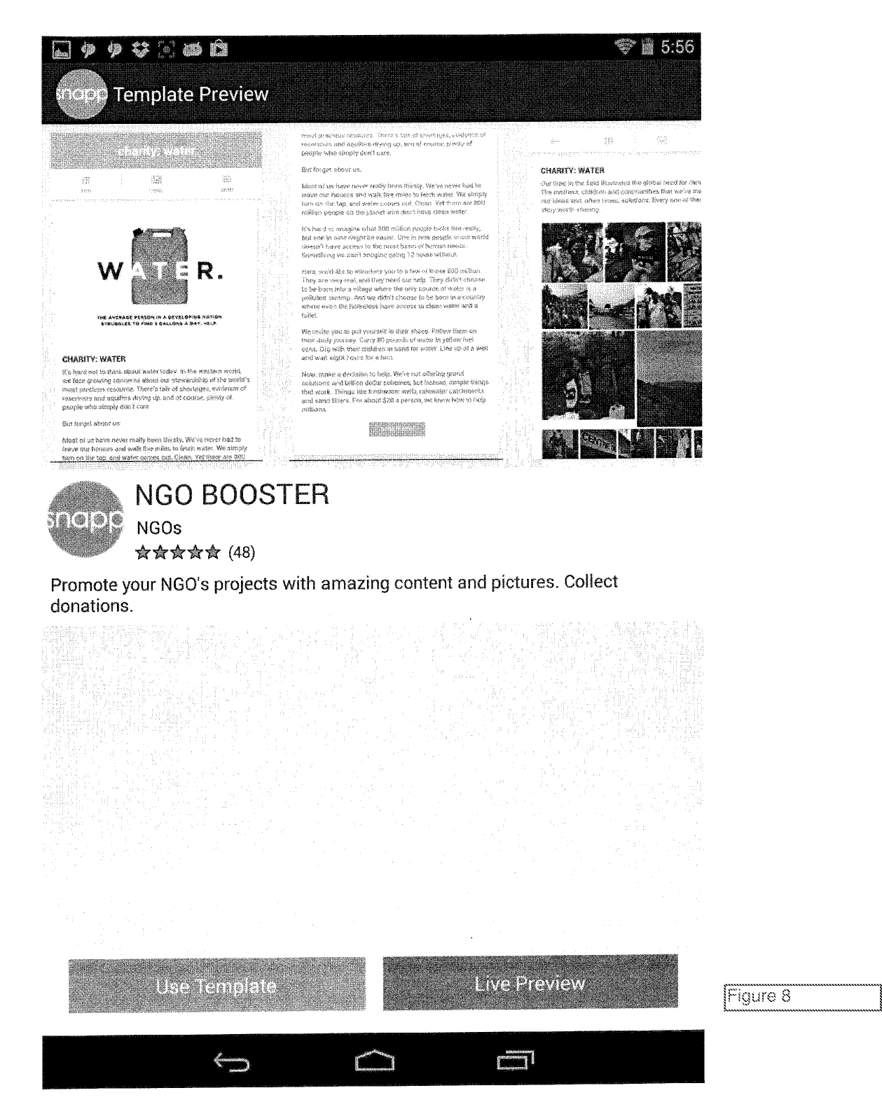

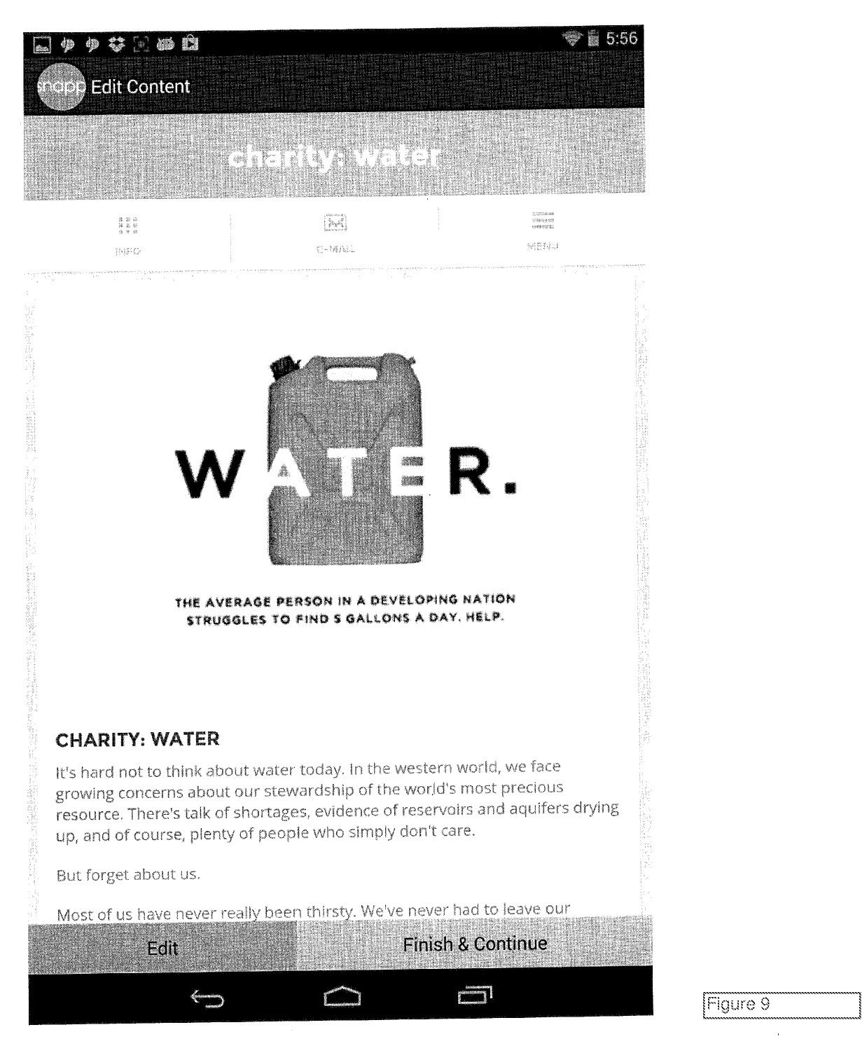

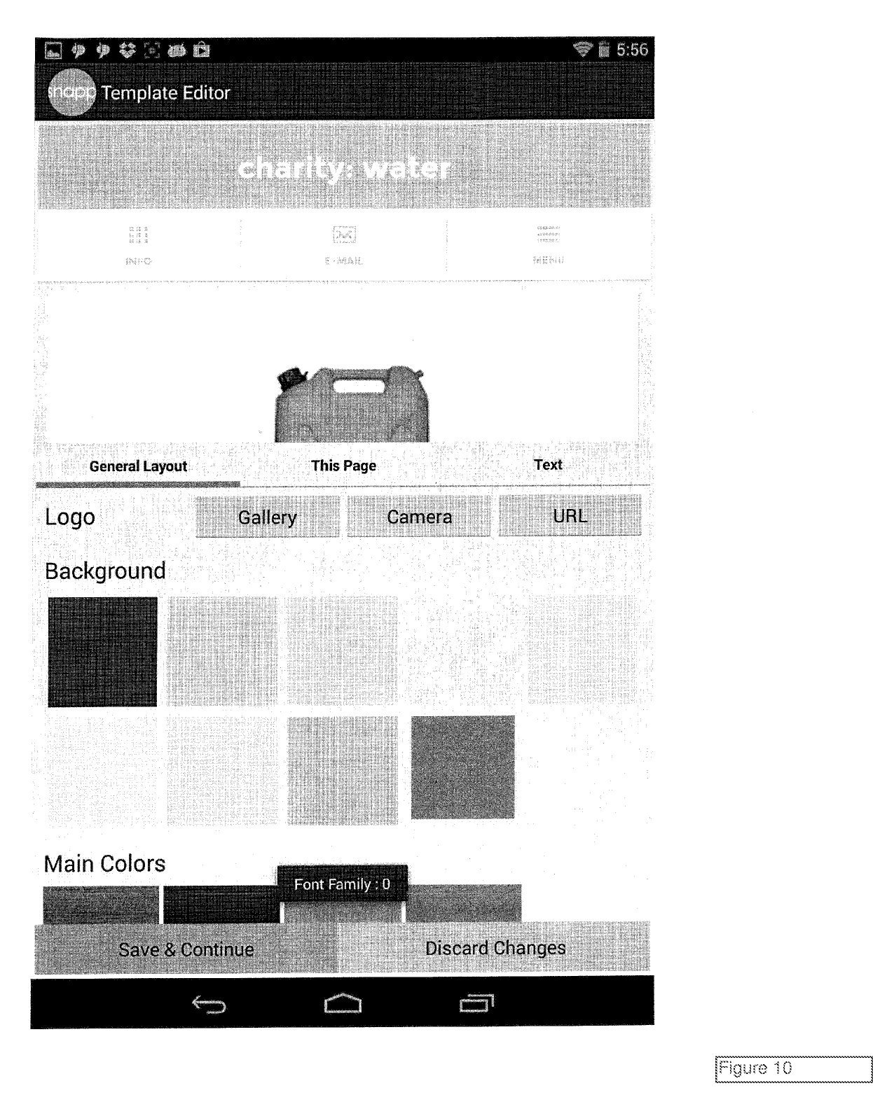

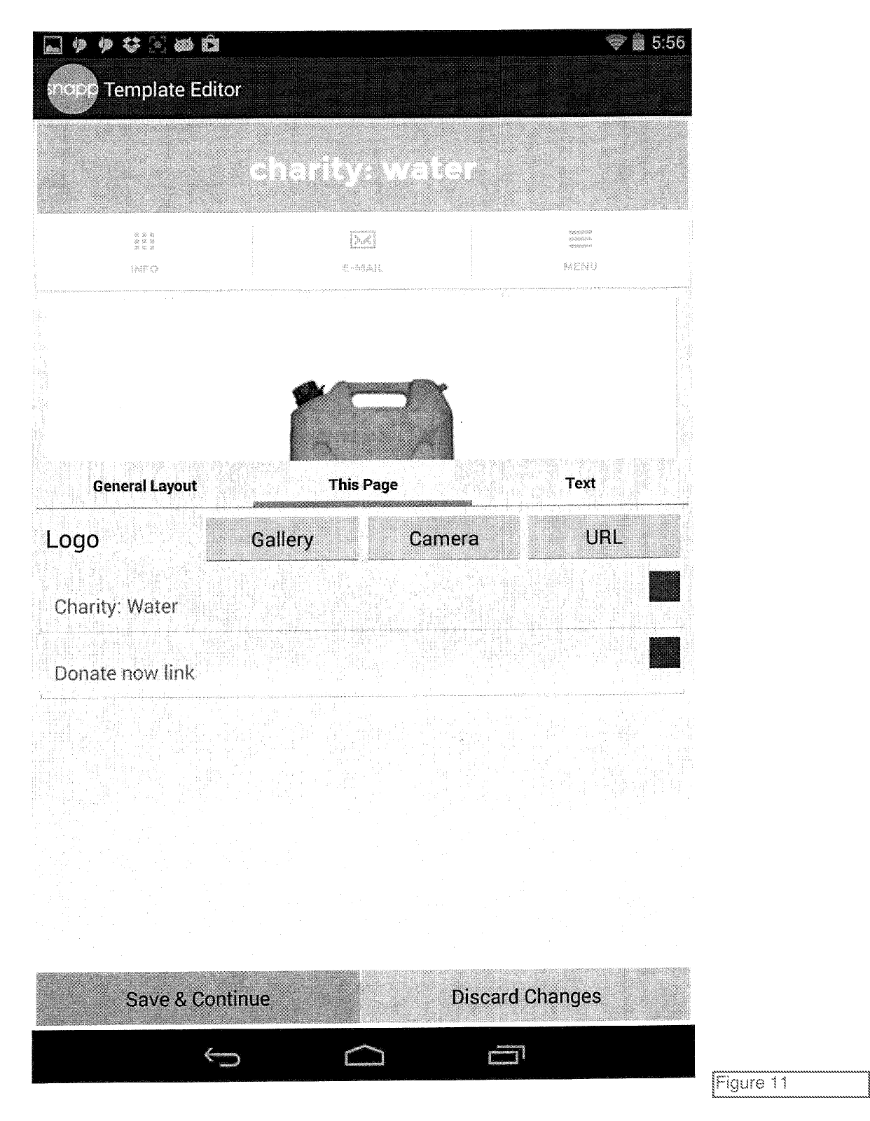

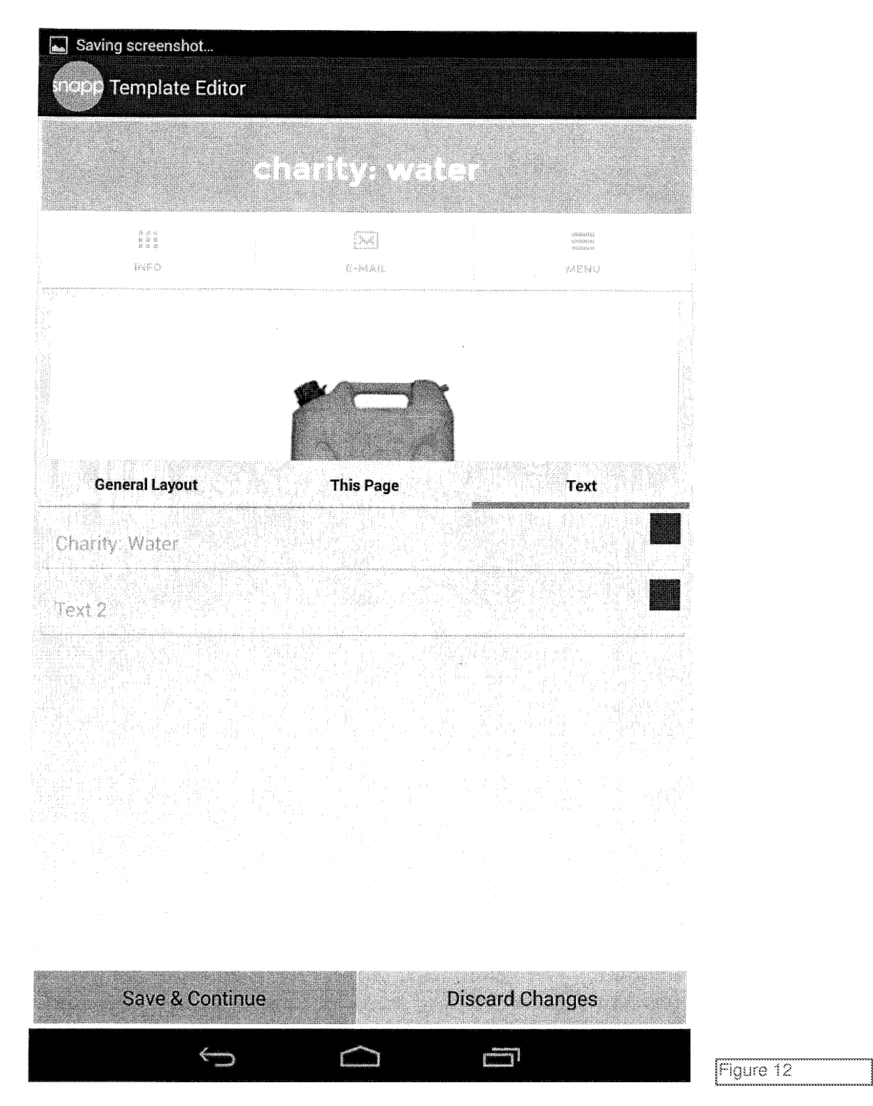

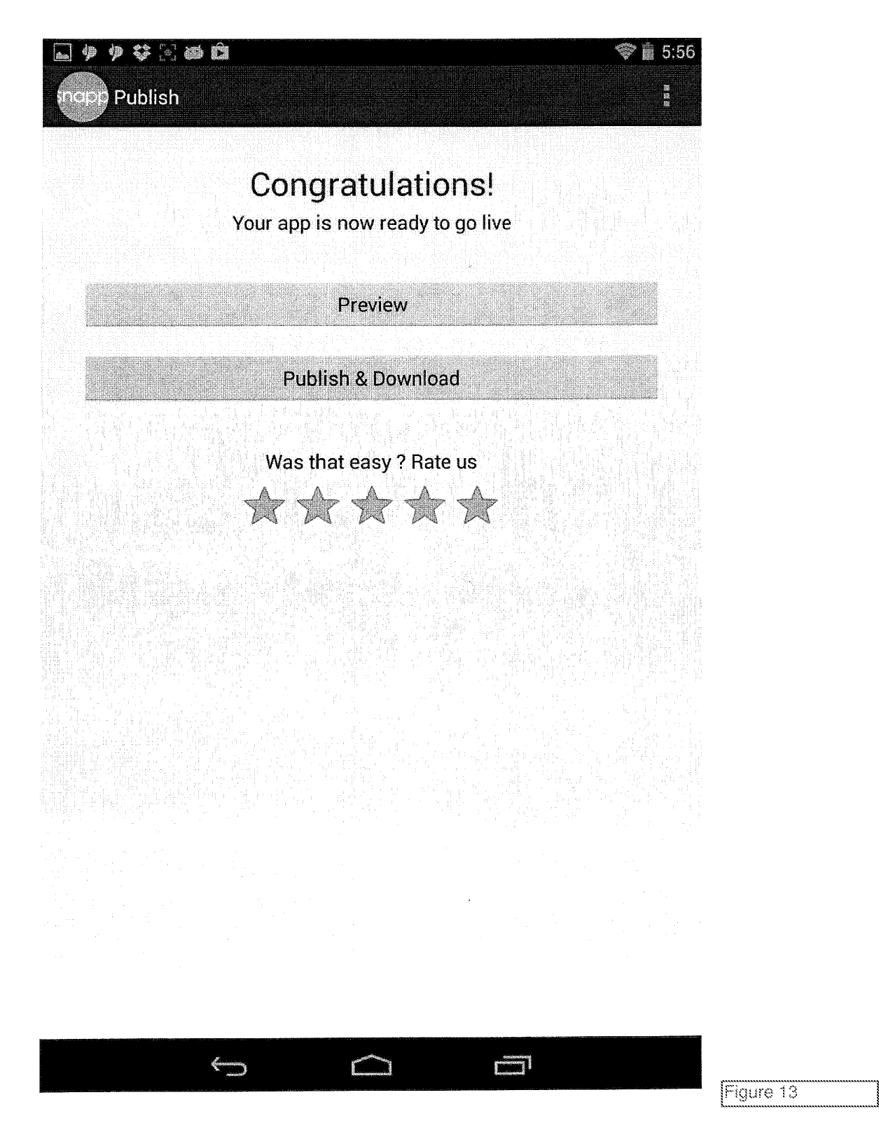

### FIELD OF THE DISCLOSURE

The present invention relates to systems and methods for building mobile device applications using a mobile device. In particular, the invention relates to an application which may be used by users of mobile computer devices and that accesses stored features, templates and/or modules for building a customized mobile device application to be employed by the user.

### BACKGROUND

Applications (or ‘apps’) for mobile computer devices, such as mobile phones, are used by people around the world for various utilities, including entertainment, business, fundraising, community building pursuits and so on. Apps are often published on application stores, which make the apps available to mobile device users around the globe. Apps can be very useful in connecting people, advertising, making sales in an ecommerce business, and many other well-known activities. However, the ability to develop apps requires specialized skill, e.g., in developing software. As such, the benefits of having a mobile device application tailored to one's own needs or wants is available only to those having either the specialized skill required to build an app, or having the financial means to hire someone having such skill.

Moreover, apps are typically developed using a PC or otherwise non-mobile computer. However, for much of the world's Internet-connected population, such non-mobile computers are not readily accessible. On the other hand, mobile computer devices may be readily available to such populations.

### SUMMARY

The present disclosure provides systems and methods for developing applications for mobile computer devices using a mobile computer device. In one aspect, the present disclosure provides a system for developing applications for mobile computer devices utilizing a mobile computer device that includes a database that is electronically accessible over at least one network system and stores features, templates and/or modules for building mobile device applications through the system. An application for building mobile device applications is included that is hosted at least partially on a server and electronically accessible over at least one network system to a user mobile computer device. The application is configured to provide a user of the user mobile computer device access to the features, templates and/or modules stored in the database, and to allow the user to build a mobile computer device application by selecting, editing and customizing the features, templates and/or modules, and to publish the mobile computer device application for use by mobile computer devices.

### BRIEF DESCRIPTION OF THE DRAWINGS

Further features and advantages of the present invention will be seen from the following description, taken in conjunction with the accompanying drawings, wherein,

Appendix A is a series of screenshots illustrating various screens presented to a user when using embodiments of the present disclosure to develop a mobile application.

### DETAILED DESCRIPTION OF THE INVENTION

The present disclosure provides systems and methods for developing mobile software applications for mobile computer devices. In some embodiments, the present disclosure provides a mobile computer device application for building mobile applications.

Many embodiments of the disclosure may take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers) and the like.

The disclosure also can be practiced in distributed computing environments, where tasks or modules are performed by remote processing devices that are linked through a communications network. Moreover, the disclosure can be practiced in Internet-based or cloud computing environments, where shared resources, software and information may be provided to computers and other devices on demand. In a distributed computing environment, program modules or subroutines may be located in both local and remote memory storage devices. Aspects of the disclosure described below may be stored or distributed on computer-readable media, including magnetic and optically readable and removable computer disks, fixed magnetic disks, floppy disk drive, optical disk drive, magneto-optical disk drive, magnetic tape, hard-disk drive (HDD), solid state drive (SSD), compact flash or non-volatile memory, as well as distributed electronically over networks including the cloud. Data structures and transmissions of data particular to aspects of the disclosure are also encompassed within the scope of the disclosure.

Appendix A is series of screenshots illustrating various screens presented to a user when using the present invention to develop a mobile application. The process allow the user to build a mobile application by using a mobile device.

The mobile application for building mobile applications may be stored on one or more network-accessible servers. The application may access one or more databases storing various features, templates and/or modules which may be used, edited or otherwise customized by a user when building a mobile computer application using the application provided by the present disclosure. For example, images, GPS mapping modules, layout and graphical user interface templates, ordering, shipping and payment modules, tools for publishing the application, and the like may be stored in a database and accessible to the application-building application provided herein.

The mobile application may include any tool, device, system, process or combination thereof, which provides users of mobile computer devices with access to the stored features, templates and/or modules for building mobile device applications. The application may include any computer-readable memory or databases, which may be stored in any computer-readable medium, and may be accessible by a computer processor. The application may further include or access computer program instructions which may cause a processor to perform any algorithms and/or functions which may be described in this disclosure.

The server(s) hosting the application for building mobile computer device applications may be or include any database capable of storing and/or providing access to information, such as an electronic database, a computer and/or computerized server, database server or generally any network host capable of storing data and connected to any type of data network. Further, the server may include or be a part of a distributed network or cloud computing environment. Any type of electronic and/or computerized device that is capable of storing information may be included as the server, and is considered within the scope of this disclosure. The server may include computer-readable storage media, and a processor for processing data and executing algorithms, including any of the processes and algorithms set forth in this disclosure. The application is electronically accessible to mobile computer devices over at least one network system. The network system may include any type of network infrastructure, such as the Internet, or any other wired, wireless and/or partially wired network. The server, application and network system may include a variety of hardware and software components to provide successful functioning of the server and the application, as is well-known within the art. Further, any features, characteristics, designs and/or functions that are known within the art may be included with the system to further enhance its efficiency.

In order to build an application a user can either start from an already existing template, or from scratch by selecting the features he want the application (e.g. he can select and deselect which features and functionalities he wants to implement in his new application).

From the mobile device he can then already see how his application is going to look like at the end of the process. He can also edit the content (e.g. pictures, video, media files, text, etc) in order to fit his particular needs.

The user can either manually insert the content himself, by pushing it from a web desktop interface, by email or text message, or by pulling it from an existing source or from the device itself (e.g. by interacting with the camera and gallery of images and videos etc.).

At the end of the process the application can be either published on a selected app store, or downloaded directly on the device. As such the user may create applications for his mobile device directly using his mobile device itself.

Further details of the present invention are seen from the attached screenshots (Appendix A).

1. A system for developing applications for mobile computer devices utilizing a mobile computer device comprising:
a database, electronically accessible over at least one network system, storing features, templates and/or modules for building mobile device applications through the system; and
an application for building mobile device applications, hosted at least partially on a server and electronically accessible over at least one network system to a user mobile computer device,
wherein the application is configured to provide a user of the user mobile computer device access to the features, templates and/or modules stored in the database, and to allow the user to build a mobile computer device application by selecting, editing and customizing the features, templates and/or modules, and to publish the mobile computer device application for use by mobile computer devices.

2. The system according to claim 1, wherein said system comprises utilizing one or more mobile computer devices.
